(19) United States
(12) Patent Application Publication
(10) Pub. No.: US 2005/0097460 A1
(43) Pub. Date: May 5, 2005

(54) GUI operating method using graphic ID information and apparatus thereof

(75) Inventor: Young-Seuk Oh, Siheung-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/974,746

(22) Filed: Oct. 28, 2004

(30) Foreign Application Priority Data
Nov. 3, 2003 (KR) 2003-77369

(51) Int. Cl. G06F 17/21

(52) U.S. Cl. 715/517; 715/520; 715/524; 715/536; 715/542

(57) ABSTRACT

A user graphic interface (GUI) operating apparatus and method using a graphic identification (ID) information, includes a text database for storing therein all text data for display on a screen under corresponding graphic ID information, a pre-processor for selecting data suitable for the displayed graphic from the text data base, and processing the selected data into a language of a country selected by a user, a text buffer for storing therein an output data from the pre-processor, and a post-processor for adjusting location, fonts and physical position of the stored data of the text buffer in accordance with circumstances, and outputting a graphic data for display on the screen. Fabricating the programs becomes simpler, and because text data are stored in accordance with graphic ID information, correcting, adding or deleting data becomes easier. Additionally, because the GUI can be performed for each function, the GUI can be easily adapted to another type of device without requiring separate modification, and as a result, compatibility of the GUI increases.

### CROSS-REFERENCE TO RELATED APPLICATIONS

This application claims the benefit, under 35 U.S.C. §119(a), of Korean Patent Application No. 2003-77369 filed Nov. 3, 2003, in the Korean Intellectual Property Office, the entire contents of which are expressly incorporated herein by reference.

### BACKGROUND OF THE INVENTION

1. Field of the Invention

The present invention relates to a user GUI operating method and apparatus that uses a graph identification information. More particularly, the present invention relates to a GUI operation method and apparatus for an efficient management of various types of text data that have both directionality and operability in a user graphic interface in audio/video (AV) devices.

2. Description of the Related Art

Recent developments in digital technology have provided a variety of electronic appliances that can perform multiple functions. These include, for example, a personal video recorder (PVR), TV, digital TV (DTV), video and computer.

Such integration of various functions into a single electronic appliance has increased the demand for more efficient display functions. Accordingly, the graphic user interface (GUI), which has not been considered very important in the past, is now much more important in terms of ease of use of the multi-function appliances.

The GUI can be used in a variety of conversational applications (an application that can operate the GUI by voice alone). The conversational GUI can be constructed to select one of several options in such devices as an AV device, computer system, TV, automatic teller machine and game console.

A rather complicated conversational GUI requires multi-menu structures. Consequently, the conversational GUI needs to be constructed as simple, efficient and active as possible, for fast and efficient operation by the users. This can be achieved by first providing a menu display suitable for the interfacing with an ergonomic input device, and secondly by providing an operation-intuitive menu display.

Although operation of the GUI in AV devices varies depending on the type of integrated circuit in use, operation of the GUI can be generally classified into four main types: graphic data processing, text data processing, flag processing for internal control, and comprehensive execution of remote controller commands or other commands.

While all of the above-mentioned processes are equally important, efforts are currently being focused on GUI text processing operations in AV devices, and they will probably remain the focus of attention for at least several decades to come. While Icons are now being used, general basic functions are still operated based on text because resources in AV devices are more limited for graphics than for computers or networks. In consideration of all that has been discussed above, the efforts of designers in the industry are focused on the management of text data and how to comprehensively embody the text data. Unfortunately, GUI for AV devices have been used for relatively simpler functions than other GUI applications, and, as a result, have been regarded as a simple matter that can be embodied without requiring complicated processes. Accordingly, development of this area has been relatively slow. As customers now prefer products with better GUI performance and better display on monitors to the products with attractive designs, however, the GUI is getting more attention, and text data processing based on a more systematic and consistent approach is thus required.

### SUMMARY OF THE INVENTION

Accordingly, it is an object of the preferred embodiments of the present invention to solve the above-mentioned problems. It is another object of the preferred embodiments of the present invention to provide a method and an apparatus of a user graphic interface operation, which utilizes GUI text object and pre-processed ID graphic information to provide convenient manufacturing, higher compatibility, and better convertibility into languages as required by the users.

The above aspects and/or other features of the embodiments of the present invention can be achieved by providing a user graphic interface (GUI) operating apparatus that uses graphic identification (ID) information. The graphic ID information includes a text database for storing therein all text data for display on a screen under the corresponding graphic ID information. The embodiments of the present invention further comprise a pre-processor for selecting data suitable for the displayed graphic from the text data base and processing the selected data into a language of a country selected by a user, a text buffer for storing therein an output data from the pre-processor, and a post-processor for adjusting location, fonts and physical position of the stored data of the text buffer in accordance with circumstances, and outputting a graphic data for display on the screen.

The graphic ID information includes a graphic type, a graphic page and a graphic position.

The data stored in the text buffer includes a text space for storing texts of languages of respective countries. The text space is used for storing terms that are fixedly used corresponding to variables at the same location. The data stored in the text buffer further includes a first space for recording therein information on the processing ways of input keys, a second space that contains information regarding direction, where a highlight moves in accordance with the input key, a third space for recording therein information about text length and font type, and a fourth space for indicating X and Y information about the physical position for the actual display of the graphic.

The pre-processor includes a text set routine for accessing a corresponding text object by using a graphic type gType, a graphic page gPage and a graphic position gPos for display of the text database on the screen, and a language set routine for changing the accessed text object. Therefore, the text data itself can be changed into a language according to a preset country language code.

According to one aspect of the present invention, a user graphic interface (GUI) operating method using graphic identification (ID) information comprises classifying substantially all the text data for display on a screen under the graphic ID information and storing the data, and selecting, based on the graphic ID information, proper data related to the graphic for display on the screen, and outputting the graphic data for display on the screen.

The graphic ID information includes a graphic type, a graphic page and a graphic position.

According to an embodiment of the present invention, outputting the data comprises selecting, based on the graphic ID information, proper data related to the graphic for display on the screen, and converting the data into a language of a country selected by a user. Outputting the data further comprises storing the converted data in a text buffer, and adjusting a location, fonts and physical position of the stored data of the text buffer in accordance with circumstances, and outputting graphic data for display on the screen.

According to the embodiments of the present invention, the data stored in the text buffer includes a text space for storing texts of languages of respective countries, and wherein the text space storing terms that are fixedly used in accordance with variables at the same location. The data stored in the text buffer further comprises a first space for recording therein information on the processing of the input keys, a second space containing information regarding direction, wherein a highlight moves in accordance with the input key, a third space for recording therein information about text length and font type, and a fourth space for indicating X and Y position information about the physical position for actual display of the graphic.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram of a GUI text object processor using graphic ID information according to an embodiment of the present invention;

FIGS. 2A to 2D are views provided for the explanation of a graphic ID generating method according to an embodiment of the present invention;

FIG. 3 shows the general structure of a text object according to an embodiment of the present invention; and

FIG. 4 is a block diagram illustrating the processing of a GUI text object using graphic ID information according to an embodiment of the present invention.

### DETAILED DESCRIPTION OF THE PREFERRED EMBODIMENTS

Certain embodiments of the present invention will be described in greater detail with reference to the accompanying drawings.

In the following description, the same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

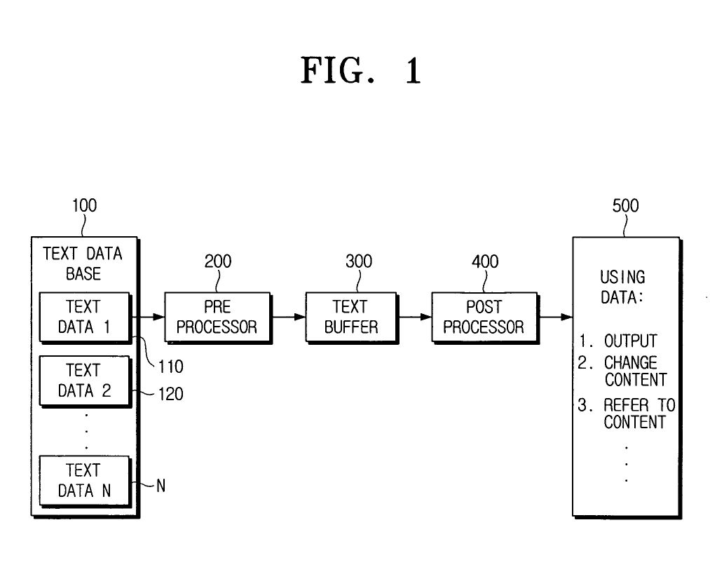

FIG. 1 is a block diagram of a GUI text object processor using graphic ID information according to an embodiment of the present invention. As shown, the GUI text object processor comprises a text database 100, a pre-processor 200, a text buffer 300, a post processor 400, and user data 500.

The text database 100 stores therein all the text data 110, 120, . . . , N in ID format, and the pre-processor 200 selects data suitable for graphics with reference to the predetermined graphic ID information, and converts the selected data into a language selected by the user. The converted data are stored in the text buffer 300.

The post processor 400 adaptively processes according to the current situation. For example, the post processor 400 selects or creates proper terms with reference to internal variables when the stored data of the text buffer 300 is required to change physical position. When the fonts need some changes and when adjustments are required for the display of a certain selected length in the length-limited part, the post-processor 400 adjusts the data and outputs the data for use as the final user data 500.

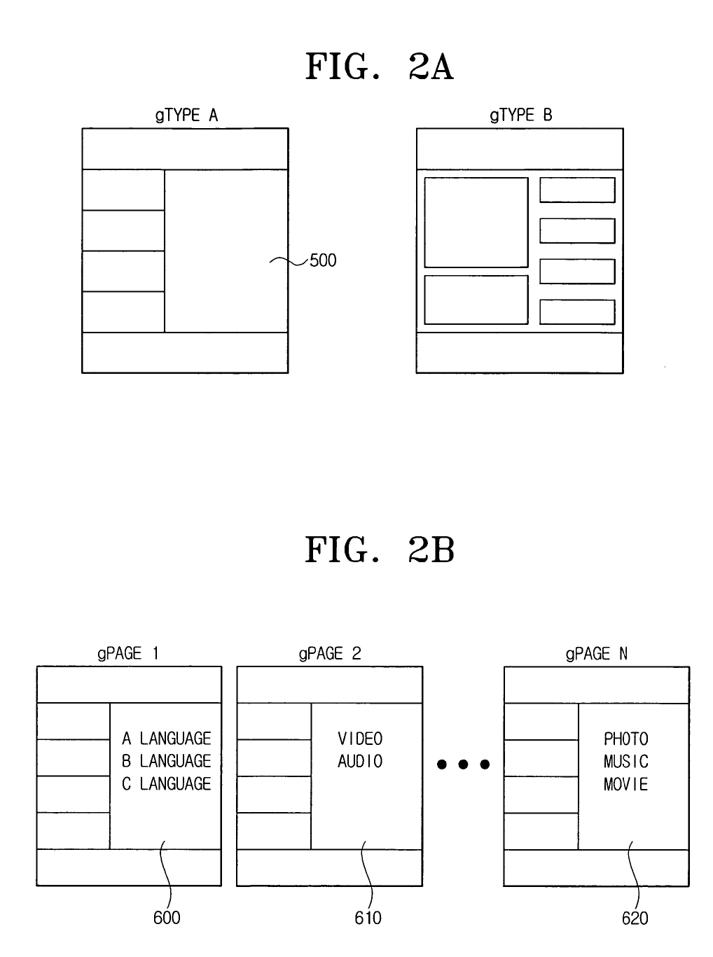

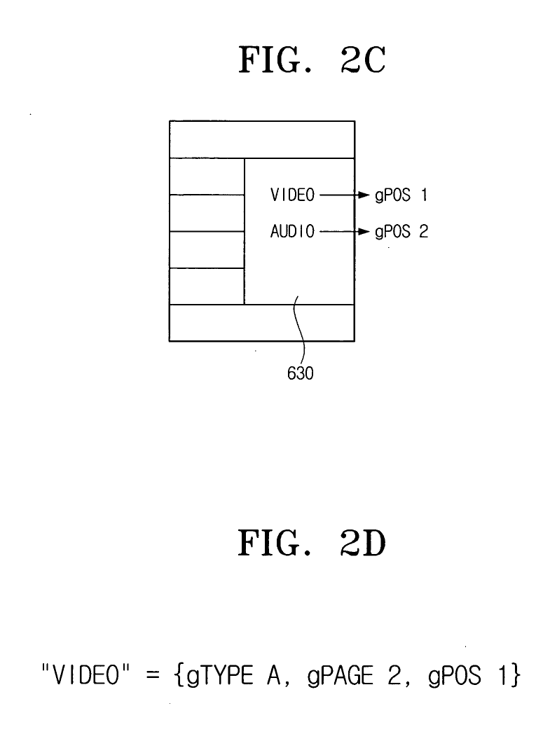

In order to assign the proper text, all the graphic ID information shown in FIGS. 2A to 2D are required. Of course, additional information can be used as circumstances dictate. For the sake of brevity and to aid in the understanding of the embodiments of the present invention, the discussion herein will focus mainly on the three types of categories that are usually used in AV devices.

FIGS. 2A to 2C illustrate the graphic ID generating method. The graphic ID information comprises a graphic type “gType” (FIG. 2A), a graphic page “gPage” (FIG. 2B), and a graphic position “gPos” (FIG. 2C). The graphic ID information gType is used for a substantially complete change of the graphic type, and influences the physical position of the graphic pages or graphic positions described below. As shown in FIG. 2A, gType is changed when the type of the graphic for display on the screen is substantially completely changed.

In the setup window of a general AV device, the contents of graphics can change while the graphic type remains the same. The graphic ID information “gPage” groups a set of similar function texts under its category and can be used to divide certain areas of the same graphic, or to use the same graphic for another purpose. Furthermore, gPage can perform a completely different function depending on which set of texts is used for which purpose.

More specifically, FIG. 2B shows the graphic ID information gPage when the graphic 600 at the right-hand side of the intermediate section 500 of its upper group, i.e., gType A, partially changes. If the graphic 600 at the right-hand side of the intermediate section of gType A changes from “A-Language, B-Language and C-Language” to “Video and Audio” 610 to “Photo, Music and Movie” 620, these can be classed as gPage 1, gPage 2, . . . , gPage N. Accordingly, a completely difference performance can result depending on how the gPage changes.

When the gType and gPage are determined as described above, the graphic ID information gPos is used for the texts that need be numbered. The gPos labels the texts of the gPage consecutively. In a preferred embodiment of the present invention, the graphic ID information gPos can be formed of text units with the highlight function. As shown in FIG. 2C, in order to divide the graphic part 600 of the right-hand side of the intermediate section of gPage 2 into video and audio sections, the video can be labeled with gPos 1 and audio can be labeled with gPos 2. Accordingly, using the classification as described above, all the graphic texts used in the AV devices can be ID-processed. An example of a classification of a video graphic text is shown in FIG. 2D. This classification uniquely identifies all the critical parameters of the graphic: the type of display (gTYPE A), the page (gPage 2) and its position (gPos 1). In a preferred embodiment of the present invention the above are determined when the functions, specification and graphic designs of the AV device are finalized.

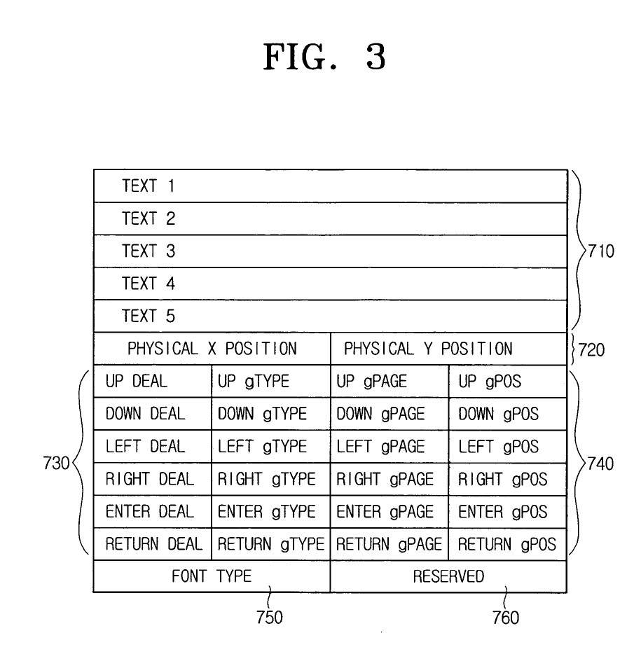

Proper text data are searched using the above graphic information IDs, and stored in the text buffer 300 as text objects. FIG. 3 shows how the information stored in the text buffer 300 is used. The completed text buffer 300 provides storage space for various language texts. Five text storage spaces 710 are provided for the terms that are predetermined to use with the respective variables in the same location. A storage area 730 stores information resulting from operation of the general operation keys of a remote controller, such as UP, DOWN, LEFT, RIGHT, ENTER, RETURN. Storage area 740 stores the information that results from the operation of the general operation keys, and stores the information as to which direction the highlight will move according to the detailed action information 730. Storage area 740 comprises all the “gTYPE”, “gPage” and “gPos” information. Occasionally, a graphics expression can be limited to a predetermined length, or the length of text can vary as the text is translated from one language to another. In order to resolve these situations, an information indicating part 750 for the font adjustment, and a physical X/Y position indication part 720 for the physical position of the actual display of the graphic are provided. A reserved area 760 can also be provided for later use.

A user GUI operating method using graphic ID information according to an embodiment of the present invention will now be described.

The GUI text object method using graphic ID information according to an embodiment of the present invention classifies a series of similar actions, and processes them into a functional formula. For example, while many movements can be expected by a highlighted area, highlighted areas on the menu graphic of the AV device generally moves in one of two ways when a key of the remote controller is input. The first case is that the highlight moves to its immediate upper location, and the second case is that the highlighted text changes.

With the above two cases in consideration, conventional approaches may require several tens of, or sometimes, several hundreds of processing steps in accordance with which kind of the graphic is in use or where the graphic is located. For example, in the first case, it would be determined, first, as to whether the current location is in the first row, and according to the type of the graphic, the graphic may be maintained or moved to the lowest row upon receipt of UP key by, for example rolling or visiting the next gPage. When moving to the last row, it should be respectively checked to see whether there is left a next gPage or how many rows the next gPage contains. The processing becomes far more complicated in the second case. Because processing is required for the each of the actions in accordance with the gType, gPage and gPos, it is practically impossible to estimate the number of possibilities.

In the following description, the above two cases are classified and processed by two methods in accordance with the embodiments of the present invention.

As an example in an embodiment of the present invention, two keys, Move and Change, are determined and target graphic ID information is set. For the Move key, the types of text objects can be completely processed by removing the highlight from the current location and searching the target GUI to highlight a new corresponding location.

In addition, the method for classifying and processing according to an embodiment of the present invention considers whether the gPage, or gType is different. This can be checked by comparing current the GUI ID with a preset GUI ID. When the GUI IDs are different, conversion into target graphic may be performed, or contents of the current gPage can be displayed with the highlight on the target area.

Additionally, each case can be subdivided and defined respectively. For example, Move can be subdivided into Move-normal, Move-gType and Move-page. As functions of each of the sub-items are processed, the sub-items are expressed into a brief and technical function.

Compared to the Move key, the Change key provides stronger function execution. Especially when there are less than 5 sub-items, processing can be performed within the text buffer of the stored text objects and therefore does not require additional data. In the case of the Change key, when the UP key is input, existing contents are removed, corresponding parameters are adjusted and corresponding texts are selected and expressed.

When there are more than 5 sub-items, or completely new text needs be made according to the values of the parameters (e.g., numerical information comprising year, month, day and time, or disc-related data such as title or name) this can be processed by using simple additional conditions that use previously known GUI ID information as in the case of the Move operation. Alternatively, the items can be classified and processed.

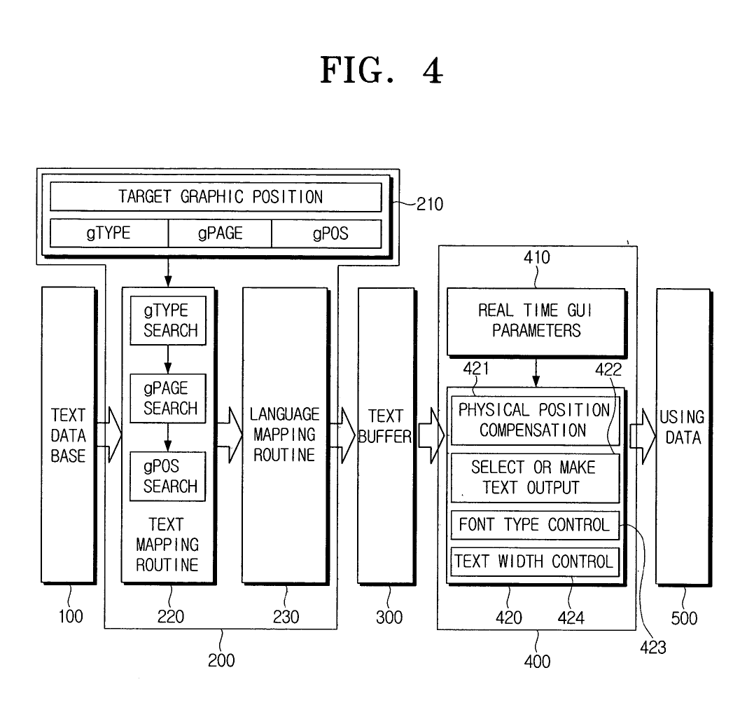

FIG. 4 is a block diagram illustrating the processing of a GUI text object using graphic ID information according to an embodiment of the present invention. Referring to FIG. 4, the process of finding proper text data using target graphic information ID, selecting data according to the language of a target country, and controlling the data of the text buffer 300 to make desired changes will be described in greater detail.

In the text database 100 shown in FIG. 4, where all the texts are ID-processed and stored, suitable (or proper) text data is retrieved by using a target graphic position 210. Text mapping routine 220 is then performed to access a corresponding text object by using target gType, gPage and gPos information. Note that the text database 100 of FIG. 4 is the same as that in FIG. 1, and the text mapping routine occurs in the pre-processor 200, also as shown in FIG. 1.

Next, in accordance with a country language code set in the setup of the AV set, a language mapping routine 230 is performed to convert the accessed text object into a target language.

As shown in FIG. 3, the text object is constructed such that it enables individual control of the text data. The text object has an efficient structure in which the text information can be changed into suitable languages using basic text object information. When the complete information is obtained through the above-mentioned processes, the information is stored in the text buffer 300 to use in the actual program.

The real time GUI parameters 410 of the post-processor 400 record therein parameters for the type or length of texts for display in a corresponding location. Using the above parameters, a compensation control unit 420 performs a physical position compensation routine 421 and a font type control routine 423 so that the texts can be properly displayed in the graphic. A select or make text output routine 422 can select the texts for routine displays, such as “On/Off” or “channel numbers 2˜125”.

A text width control routine 424 can express characters in a string. For example, the text width control routine 424 expresses 10 characters in a string, and if the data contains more than 30 characters, chops the data appropriately so that only 10 characters can be displayed. The post-processor 400 operates to display characters of the text buffer 300. After completing the above processes, the text object, which is adjusted to the needs of the user, is displayed in the using data 500 as the actual data.

The user GUI operating method described above that uses graphic ID information according to the embodiments of the present invention reduces the scope and complexity when dealing with a plurality of cases. Also, because a single functional formula is required for this process, the sources requirement for the actual program is reduced. Furthermore, because classification under functions is enabled, the entire source can be orderly arranged. This provides other advantages such as bug prevention, and easy and simple program fabrication.

Secondly, because the single functional formula and the text data are operated separately from each other, text data can be managed separately. Furthermore, because text data is stored in accordance with the graphic ID information, locating the target data becomes easier. As a result, debugging of the program, or modification, addition and deletion of the text data is much easier.

Thirdly, because the GUI is executed in each function, the functional formulas used in one AV device are also usable in other AV set without requiring separate modification. As a result, compatibility increases, and time for research and development of models can be greatly shortened.

Lastly, because the pre-processor provides conversion of text data into user-desired language using the internal parameters of the AV device during the storage of data in the buffer, language conversion is much easier.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A graphic user interface (GUI) operating apparatus using graphic identification (ID) information, comprising:
a text database adapted to store therein all text data for display on a screen under corresponding graphic ID information;
a pre-processor adapted to select data suitable for the displayed graphic from the text database, and process the selected data into a language of a country selected by a user;
a text buffer adapted to store therein an output data from the pre-processor; and
a post-processor adapted to adjust location, fonts and physical position of the stored output data of the text buffer in accordance with circumstances, and output a graphic data for display on the screen.

2. The user GUI operating apparatus of claim 1, wherein the graphic ID information comprises a graphic type, a graphic page and a graphic position.

4. The user GUI operating apparatus of claim 1, wherein the output data stored in the text buffer comprises:
a text space adapted to store texts of languages of respective countries, the text space for storing terms that are fixedly used corresponding to variables at a same location;
a first space adapted to record therein information on the processing ways of input keys;
a second space adapted to contain information of direction where a highlight moves in accordance with the input key;
a third space adapted to record therein information about text length and font type; and
a fourth space adapted to indicate X and Y information about a physical position for actual display on the graphic.

5. The user GUI operating apparatus of claim 1, wherein the pre-processor comprises:
a text set routine adapted to access a corresponding text object by using a graphic type gType, a graphic page gPage and a graphic position gPos for display of the text database on the screen; and
a language mapping routine adapted to change the accessed text object, and therefore, change the text data itself into a language according to a preset country language code.

3. The user GUI operating apparatus of claim 2, wherein the graphic ID information gType is used when the type of the graphic changes substantially completely, the graphic ID information gPage is used when a certain area of the same graphic is divided, or when the same graphic is used for different purposes, and the graphic ID information gPos is used to label the texts of the gPage consecutively and when the texts need to be numbered in a certain order in a selected area.

6. The user GUI operating apparatus of claim 1, wherein the post-processor comprises:
a real time GUI parameter part adapted to record therein parameters for the type or the length of the text displayed in a corresponding location; and
a compensation control part adapted to control the location and font of the display so that the text can be properly displayed in the graphic using the parameters.

7. The user GUI operating apparatus of claim 6, wherein the compensation control part further comprises a select or make text output part adapted to select text for routine display.

8. The user GUI operating apparatus of claim 6, wherein the compensation control part further comprises a text width control adapted to express characters in a string.

9. A graphic user interface (GUI) operating method using a graphic identification (ID) information, comprising:
classifying all text data for display on a screen according to graphic ID information and storing the text data; and
selecting, based on the graphic ID information, proper data related to the graphic ID information for display on the screen, and outputting the graphic data for display on the screen.

10. The user GUI operating method of claim 9, wherein the graphic ID information comprises a graphic type, a graphic page and a graphic position.

12. The user GUI operating method of claim 9, wherein the step of outputting the graphic data for display on the screen comprises:
selecting, based on the graphic ID information, proper data related to the graphic ID information for display on the screen, and converting the proper data into a language of a country selected by a user;
storing the converted data in a text buffer; and
adjusting location, fonts and physical position of the stored converted data of the text buffer in accordance with circumstances, and outputting graphic data for display on the screen.

13. The user GUI operating method of claim 12, wherein the converted data stored in the text buffer comprises:
a text space adapted to store texts of languages of respective countries, the text space for storing terms which are fixedly used corresponding to variables at the same location;
a first space adapted to record therein information on the processing ways of input keys;
a second space adapted to contain information of direction where a highlight moves in accordance with the input key;
a third space adapted to record therein information about text length and font type; and
a fourth space adapted to indicate X and Y information about a physical position for actual display on the graphic.

11. The user GUI operating method of claim 10, wherein the graphic ID information graphic type is used when the type of the graphic changes substantially completely, the graphic ID information graphic page is used when a certain area of the same graphic is divided, or when the same graphic is used for different purposes, and the graphic ID information graphic position is used to label the texts of the graphic page consecutively and when the texts need to be numbered in a certain order in a selected area.

14. A computer readable medium for a graphic user interface (GUI) using a graphic identification (ID) information, comprising:
a first set of instruction code adapted to classify all text data for display on a screen according to graphic ID information and storing the text data; and
a second set of instruction code adapted to select, based on the graphic ID information, proper data related to the graphic ID information for display on the screen, and further adapted to output the graphic data for display on the screen.

15. The computer readable medium for a graphic user interface (GUI) using a graphic identification (ID) information of claim 14, wherein the graphic ID information comprises a graphic type, a graphic page and a graphic position.

16. The computer readable medium for a graphic user interface (GUI) using a graphic identification (ID) information of claim 15, wherein the graphic ID information graphic type is used when the type of the graphic changes substantially completely, the graphic ID information graphic page is used when a certain area of the same graphic is divided, or when the same graphic is used for different purposes, and the graphic ID information graphic position is used to label the texts of the graphic page consecutively and when the texts need to be numbered in a certain order in a selected area.

17. The computer readable medium for a graphic user interface (GUI) using a graphic identification (ID) information of claim 14, wherein the second set of instruction code adapted to output the graphic data for display on the screen comprises:
a third set of instruction code adapted to select, based on the graphic ID information, proper data related to the graphic ID information for display on the screen, and converting the proper data into a language of a country selected by a user;
a fourth set of instruction code adapted to store the converted data in a text buffer; and
a fifth set of instruction code adapted to adjust location, fonts and physical position of the stored converted data of the text buffer in accordance with circumstances, and further adapted to output graphic data for display on the screen.

18. The computer readable medium for a graphic user interface (GUI) using a graphic identification (ID) information of claim 17, wherein the converted data stored in the text buffer comprises:
a text space adapted to store texts of languages of respective countries, the text space for storing terms which are fixedly used corresponding to variables at the same location;
a first space adapted to record therein information on the processing ways of input keys;
a second space adapted to contain information of direction where a highlight moves in accordance with the input key;
a third space adapted to record therein information about text length and font type; and
a fourth space adapted to indicate X and Y information about a physical position for actual display on the graphic.
